(19) United States
(12) Patent Application Publication
(10) Pub. No.: US 2018/0076561 A1
(43) Pub. Date: Mar. 15, 2018

(54) PACKING AND SHIELD CONNECTOR

(71) Applicant: Yazaki Corporation, Tokyo (JP)

(72) Inventor: Kengo Aoshima, Shizuoka (JP)

(21) Appl. No.: 15/703,570

(22) Filed: Sep. 13, 2017

(30) Foreign Application Priority Data
Sep. 15, 2016 (JP) 2016-180239

(51) Int. Cl. H01R 13/52; H01R 13/40; H01R 13/648

(52) U.S. Cl. CPC H01R 13/5202; H01R 13/648; H01R 13/40

(57) ABSTRACT

A shield connector has a packing. The packing has a plurality of tubular packing bodies that respectively mates with a plurality of tubular portions that respectively accommodating one or more electric wires connected to terminals in a connector housing, and have inner circumferential surfaces making contact with the tubular portions, and a connecting portion that connects the neighboring packing bodies. Each packing body has a first seal surface connected to an outer circumferential surface of the connecting portion in a connector insertion direction side out of an outer circumferential surface, and a second seal surface formed to extend in a circumferential direction and provided in a connector removal direction side. The first seal surface makes contact with the casing. Each second seal surface makes contact with each of a plurality of shield shells.

### CROSS-REFERENCE TO RELATED APPLICATION(S)

The present application claims priority to and incorporates by reference the entire contents of Japanese Patent Application No. 2016-180239 filed in Japan on Sep. 15, 2016.

### BACKGROUND OF THE INVENTION

### 1. Field of the Invention

The present invention relates to a packing and a shield connector.

### 2. Description of the Related Art

In the related art, there is disclosed a shield connector that electrically connects a shield shell housed in a connector housing and a casing of an electric apparatus to each other to perform grounding (earth) by installing the connector housing in the conductive casing of the electric apparatus (for example, see Japanese Patent No. 3595132).

However, some of the shield connectors described above have a packing for preventing intrusion of liquid from a gap between the casing and the connector housing and intrusion of liquid from a gap between the connector housing and the shield shell.

The aforementioned packing is provided in the shield shell as many as the number of poles of terminals of the shield connector. For this reason, the casing is necessarily provided with waterproof slots as many as the number of poles of terminals of the shield connector. Fabrication of a plurality of waterproof slots necessitates man hours.

### SUMMARY OF THE INVENTION

In view of the aforementioned problems, the present invention is to provide a packing and a shield connector capable of simplifying fabrication of waterproof slots of a casing.

In order to solve the above mentioned problem and achieve the object, a packing according to one aspect of the present invention, the packing having elasticity and partially interposed between a connector housing and a conductive casing while the connector housing has an insertion state into a connector through-hole formed in the casing, the packing includes a plurality of tubular packing bodies that respectively mates with a plurality of tubular portions respectively accommodating one or more electric wires connected to terminals in the connector housing, and have inner circumferential surfaces making contact with the tubular portions; and a connecting portion that connects the neighboring packing bodies, wherein a first seal surface connected to an outer circumferential surface of the connecting portion is provided in a connector insertion direction side out of an outer circumferential surface of each of the packing bodies, a second seal surface extending in a circumferential direction is formed in a connector removal direction side opposite to the connector insertion direction out of the outer circumferential surface of each of the packing bodies, the first seal surface makes contact with the casing, the second seal surface has an end of the connector insertion direction making contact with the casing and a portion buried in the connector housing, and the second seal surface makes contact with each of a plurality of shield shells that encapsulate each electric wire accommodated in each of the tubular portions.

According to another aspect of the present invention, in the packing, it is preferable that the connecting portion has a cavity, and the cavity is blocked by an insertion member other than the packing.

According to still another aspect of the present invention, in the packing, it is preferable that the connecting portion has at least an opening formed in the connector removal direction, and a cavity is provided to have a portion inserted into the connector housing from the opening in the insertion state.

In order to achieve the object, a shield connector according to still another aspect of the present invention includes two or more electric wires each of which is connected to a terminal; a connector housing provided with at least one or more tubular portions respectively mating with the electric wires to accommodate and hold each of the electric wires; and a plurality of shield shells each of which has an end of a connector insertion direction making contact with a conductive casing and a portion buried in the connector housing, each of the shield shells encapsulating each of the electric wires; and an elastic packing, wherein the packing is partially interposed between the connector housing and the casing while the connector housing has an insertion state into a connector through-hole formed in the casing, the packing has a plurality of tubular packing bodies that respectively mates with the plurality of tubular portions and have inner circumferential surfaces making contact with the tubular portions, and a connecting portion that connects the neighboring packing bodies, a first seal surface connected to an outer circumferential surface of the connecting portion is provided in a connector insertion direction side out of an outer circumferential surface of each of the packing bodies, a second seal surface extending in a circumferential direction is formed in a connector removal direction side opposite to the connector insertion direction out of the outer circumferential surface of each of the packing bodies, the first seal surface makes contact with the casing, and each of the second seal surfaces makes contact with each of the shield shell.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a schematic configuration of a shield connector according to an embodiment;

FIG. 2 is a cross-sectional view illustrating a schematic configuration of the shield connector according to the embodiment;

FIG. 3 is an enlarged view illustrating a portion A of FIG. 2; and

FIG. 4 is a perspective view illustrating a schematic configuration of a packing according to an embodiment.

### DETAILED DESCRIPTION OF THE PREFERRED EMBODIMENTS

A packing and a shield connector according to embodiments of the present invention will now be described in details with reference to the accompanying drawings. Note that the present invention is not limited by the embodiments described below. In additions, elements described in the following embodiments include those that can be easily substituted by a so-called person ordinarily skilled in the art, or their substantial equivalents. Furthermore, the elements described in the following embodiments may include various omissions, substitutions, and modifications without departing from the spirit and scope of the invention.

### Embodiments

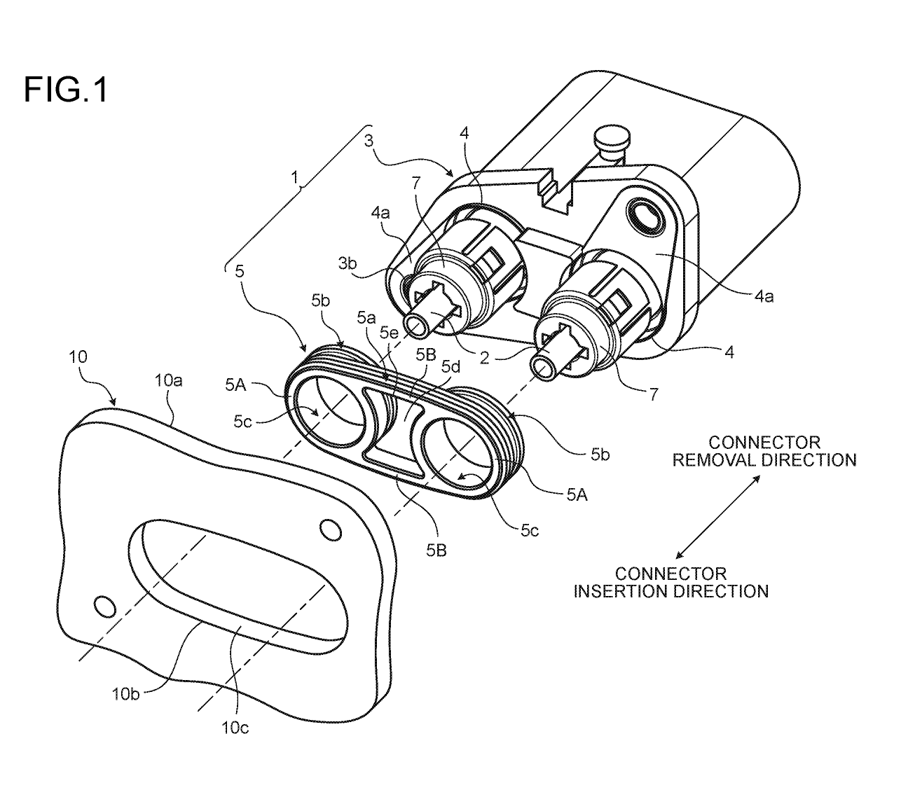

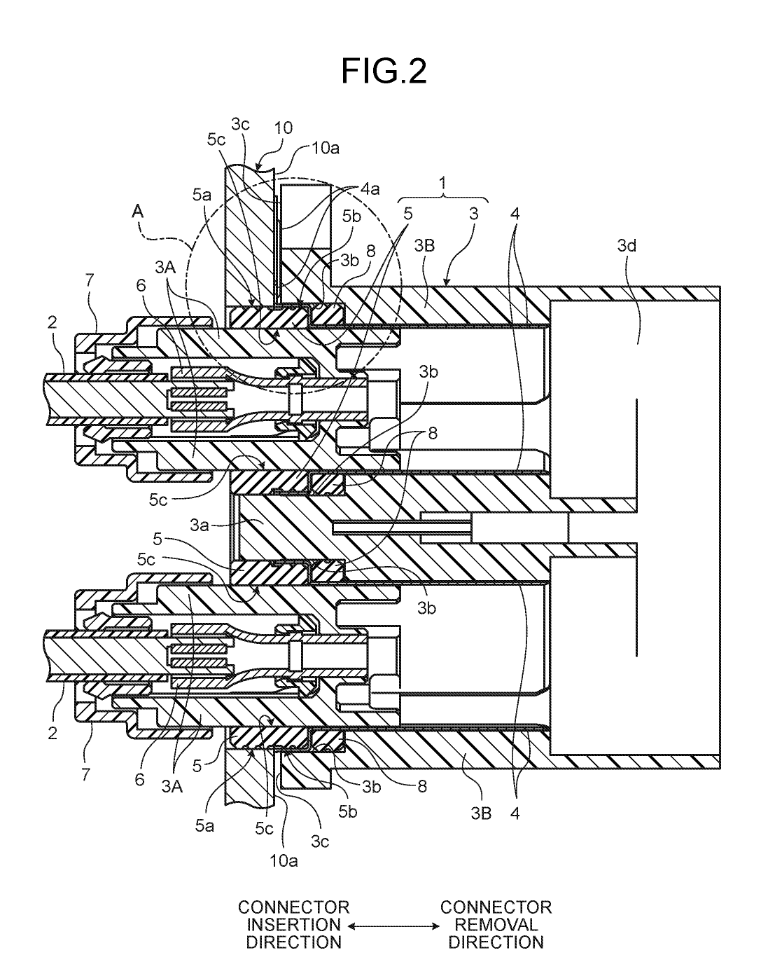

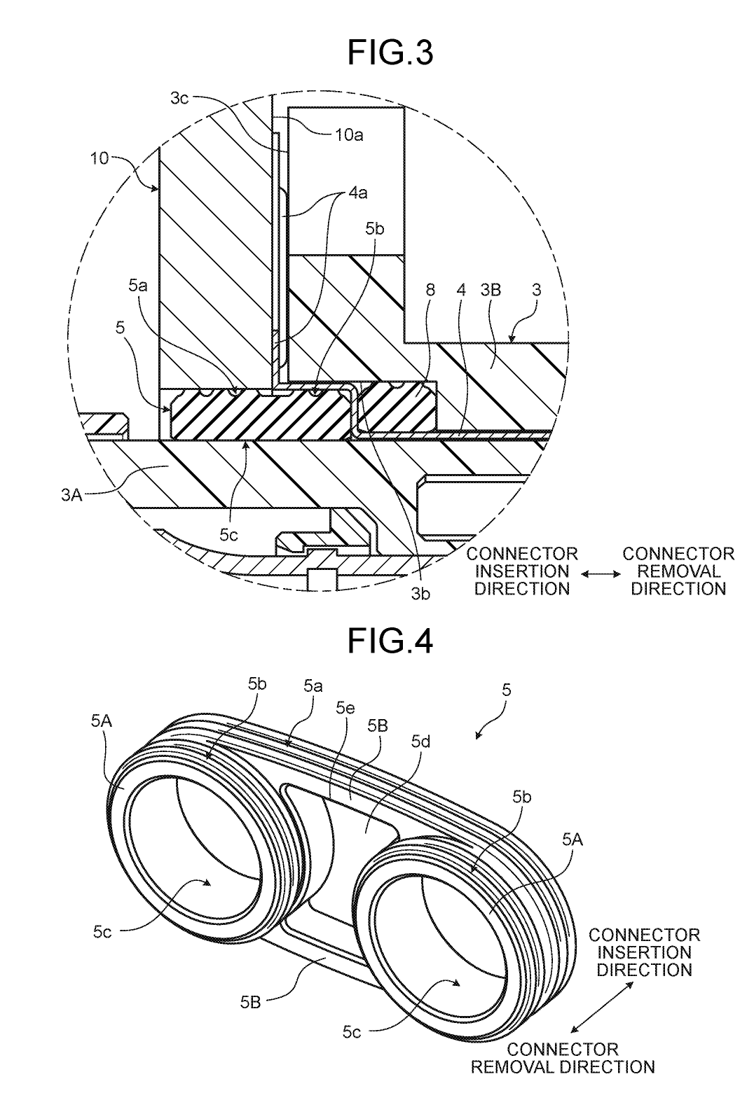

A packing and a shield connector according to this embodiment will be described with reference to FIGS. 1 to 4. FIG. 1 is an exploded perspective view illustrating a schematic configuration of a shield connector according to an embodiment. FIG. 2 is a cross-sectional view illustrating a schematic configuration of the shield connector according to the embodiment. FIG. 3 is an enlarged view illustrating a portion A of FIG. 2. FIG. 4 is a perspective view illustrating a schematic configuration of a packing according to an embodiment. Note that FIG. 1 illustrates a state in which a rear holder is installed in a pair of tubular portions of a connector housing.

A shield connector 1 illustrated in FIGS. 1 and 2 is a shielded connector mounted on a vehicle such as an electric vehicle (EV), a hybrid electric vehicle (HEV), and a plug-in hybrid electric vehicle (PHEV) to supply electric power to an inverter, a motor, or the like and supply electric signals to various electronic units. The shield connector 1 according to this embodiment includes at least two terminals serving as an electric connector and prevents radiation of electric noise to the outside by covering the terminal and a part of an electric wire connected to this terminal. This shield connector 1 is a female connector fitted to a counter part of a pair of male and female connectors, that is, a male connector (not illustrated) to house a female terminal conductively connected to the male terminal housed in this male connector. The shield connector 1 is installed in a casing 10 of an electronic unit such as an inverter or a motor while interposing a packing 5.

Note that, in the following description, the shield connector 1 has a removal direction opposite to an insertion direction of the connector. Here, the insertion direction of the connector against the shield connector 1 will be referred to as a “connector insertion direction,” and the removal direction of the connector against the shield connector 1 will be referred to as a “connector removal direction.” In addition, unless such both directions are specified, those will be referred to as a “connector insertion/removal direction.”

Specifically, as illustrated in FIGS. 1 and 2, the shield connector 1 includes two electric wires 2, a connector housing 3, a pair of shield shells 4, and a packing 5.

The electric wire 2 includes a conductive core wire formed by a plurality of strands (not illustrated) and an insulating cladding portion that covers an outer circumference side of the core wire. A female terminal (hereinafter, simply referred to as a “terminal”) 6 electrically connected to a male terminal (not illustrated) which is a male connector side is crimped to a tip of the electric wire 2. The terminal 6 is formed of conductive metal and the like. According to this embodiment, a part of the two electric wires 2 is accommodated in a connector housing 3 as an element of the shield connector 1.

The connector housing 3 is formed of insulating synthetic resin or the like. The connector housing 3 according to this embodiment houses and holds the shield shell 4 and a part of the two electric wires 2 each of which is connected to the terminal 6. Specifically, the connector housing 3 includes a pair of tubular portions 3A and a housing body 3B. Each tubular portion 3A extends from the housing body 3B in the connector insertion direction and accommodates a part of the electric wire 2 connected to the terminal 6. As illustrated in FIG. 2, the housing body 3B houses two shield shells 4. The housing body 3B includes a protrusion 3a, an inner circumferential surface 3b, a casing installation surface 3c, and a connector insertion cavity 3d. The protrusion 3a is a portion protruding in the connector insertion direction between a pair of tubular portions 3A. That is, the protrusion 3a is a portion inserted into the packing 5 as a part of the connector housing 3 in an insertion state of the connector housing 3. The insertion state of the connector housing 3 herein refers to a state in which the shield connector 1 is installed in a casing 10 described below. More specifically, this means a state in which the tubular portion 3A of the connector housing 3 is inserted into a connector through-hole 10b formed in the casing 10. The inner circumferential surface 3b is a portion formed in a circumferential direction and in a position facing an outer circumferential surface of an end of the connector removal direction of the tubular portion 3A, in the housing body 3B. The inner circumferential surface 3b partially makes contact with the outer circumferential surface of the shield shell 4. The casing installation surface 3c is a portion installed in the casing 10 in the insertion state of the connector housing 3. The connector insertion cavity 3d is a portion where the male connector (not illustrated) is inserted. A rear holder 7 where the electric wire 2 is inserted is fitted to an end of the connector insertion direction of the tubular portion 3A. The rear holder 7 is an electric wire holding member formed of insulating synthetic resin to hold each electric wire 2 while they are inserted. The rear holder 7 is locked to the outer circumferential surface of the tubular portion 3A.

The shield shell 4 is formed of conductive metal or the like and is molded in a tubular shape. The shield shell 4 is housed in the connector housing 3 as many as the number of poles, that is, the number of terminals. That is, in this embodiment, two shield shells 4 are housed in the housing body 3B. Each shield shell 4 is arranged in the connector insertion/removal direction to accommodate a part of the electric wire 2 connected to the terminal 6. The shield shell 4 has a contact 4a extending perpendicularly to the connector insertion/removal direction from an end of the connector insertion direction of the shield shell 4. The contact 4a is nipped between a connector installation surface 10a of the casing 10 and the casing installation surface 3c of the connector housing 3 in the insertion state of the connector housing 3.

The packing 5 is a waterproofing member capable of preventing intrusion of liquid into the insides of the casing 10 and the connector housing 3 from a gap between the casing 10 and the connector housing 3 in the insertion state of the connector housing 3. That is, the packing 5 is partially interposed between the connector housing 3 and the casing 10 while it is inserted into the connector through-hole 10b formed in the casing 10. The packing 5 is formed of elastic synthetic resin or the like. The packing 5 is formed of, for example, various synthetic rubber such as silicon rubber, acrylic rubber, and fluorine rubber. As illustrated in FIG. 4, the packing 5 includes a pair of packing bodies 5A and a connecting portion 5B that connects the pair of neighboring packing bodies 5A. Each packing bodies 5A mates with each tubular portion 3A of the connector housing 3 and has a tubular shape such that an inner circumferential surface 10c makes contact with the tubular portion 3A. Each packing body 5A is provided with a first seal surface 5a that connects the outer circumferential surface of the connecting portion 5B to the connector insertion direction side out of the outer circumferential surface. The first seal surface 5a is a part making contact with the casing 10. That is, the first seal surface 5a elastically makes contact with the inner circumferential surface 10c of the connector through-hole 10b formed in the casing 10 in the insertion state of the connector housing 3. In addition, each packing body 5A is provided with a pair of second seal surfaces 5b formed along a circumferential direction in the connector removal direction side of the outer circumferential surface. Each of the second seal surfaces 5b makes contact with a pair of shield shells 4. That is, an end of the connector insertion direction of each of the second seal surfaces 5b makes contact with the casing 10, and a part thereof is buried in the connector housing 3. In addition, each of the second seal surfaces 5b makes contact with each of the pair of shield shells 4 that encapsulates the electric wire 2 accommodated in each tubular portion 3A. The first and second seal surfaces 5a and 5b are preferably provided with a plurality of ribs as illustrated in FIG. 4. The connecting portion 5B has a cavity 5d and an opening 5e. The cavity 5d is a portion where the protrusion 3a as a part of the connector housing 3 is inserted from the opening 5e in the insertion state of the connector housing 3. The opening 5e is formed in the connector removal direction of the connecting portion 5B and constitutes a part of the cavity 5d. According to this embodiment, the shield connector 1 has a tubular auxiliary packing 8 formed of elastic synthetic resin or the like in addition to the packing 5 as illustrated in FIGS. 2 and 3. The auxiliary packing 8 is arranged between the inner circumferential surface 3b of the connector housing 3 and the outer circumferential surface of the shield shell 4 in the connector removal direction side from the position of the packing 5 to seal a gap between the connector housing 3 and the shield shell 4.

The casing 10 is a casing included in the electronic unit such as an inverter or a motor. The casing 10 is formed of conductive metal or the like. The casing 10 is electrically connected to the shield shell 4 in the insertion state of the connector housing 3. That is, the shield connector 1 is grounded (earth) as the contact 4a of the shield shell 4 is electrically connected to the casing 10 while it is installed in the casing 10. The casing 10 includes a connector installation surface 10a, a connector through-hole 10b, and an inner circumferential surface 10c. The connector installation surface 10a is a portion where the casing installation surface 3c of the connector housing 3 is adhered by interposing the contact 4a of the shield shell 4. The connector through-hole 10b is a so-called waterproof slot penetrating the casing 10 in a thickness direction, that is, in the connector insertion/removal direction. According to this embodiment, the connector through-hole 10b has an elliptical shape similar to a circumferential shape of the outer circumferential surface of the packing 5. The inner circumferential surface 10c is a portion making contact with the second seal surface 5b of the outer circumferential surface of the packing 5.

In the shield connector 1 configured as described above, the first seal surface 5a formed in the connector insertion direction side out of the outer circumferential surface of the packing 5 elastically makes contact with the inner circumferential surface 10c of the connector through-hole 10b so as to prevent intrusion of liquid from a gap between the casing 10 and the connector housing 3. Meanwhile, the second seal surface 5b formed along a circumferential direction of the connector removal direction side makes contact with the connector housing 3 by interposing the shield shell 4, so as to prevent intrusion of liquid from a gap between the connector housing 3 and the shield shell 4. In this manner, the packing 5 has the first seal surface 5a that integrally waterproofs the gap between the casing 10 and the connector housing 3, a plurality of second seal surfaces 5b that individually waterproofs gaps between the connector housing 3 and the pair of shield shells 4. Therefore, the two connector through-holes formed in the casing 10 can be integrated into a single hole. As a result, it is possible to simplify fabrication of the waterproof slots for the casing 10 just by forming a single connector through-hole 10b as a waterproof slot in the casing 10.

In the packing 5 according to the aforementioned embodiment, an inner circumferential surface 5c has a plurality of tubular packing bodies 5A that make contact with the tubular portion 3A of the connector housing 3 and a connecting portion 5B that connects the neighboring packing bodies 5A. Each packing body 5A has a first seal surface 5a formed in the connector insertion direction side out of the outer circumferential surface to connect the outer circumferential surface to the outer circumferential surface of the connecting portion 5B and a second seal surface 5b formed in the connector removal direction along the circumferential direction. The first seal surface 5a makes contact with the casing 10, and each of the second seal surfaces 5b makes contact with each of a plurality of shield shells 4. In this configuration, it is possible to integrate two packings provided for each shield shell depending on the number of poles of the terminals in the shield connector 1. Therefore, the two connector through-holes provided in the casing 10 can be integrated into a single hole. As a result, it is possible to simplify fabrication of the waterproof slots for the casing 10 just by forming a single connector through-hole 10b as a waterproof slot.

The packing 5 described above is partially interposed between the connector housing 3 inserted into the connector through-hole 10b provided in the conductive casing 10 and the casing 10 and has elasticity. In addition, the packing 5 has a plurality of tubular packing bodies 5A that respectively mates with a plurality of tubular portions 3A that accommodate each of one or more electric wires 2 connected to the terminals 6 in the connector housing 3 and have inner circumferential surfaces 5c that make contact with the tubular portions 3A, and a connecting portion 5B that connects the neighboring packing bodies 5A. A first seal surface 5a connected to the outer circumferential surface of the connecting portion 5B is provided in the connector insertion direction side out of the outer circumferential surface of each packing body 5A. A second seal surface 5b extending along the circumferential direction is provided in the connector removal direction side opposite to the connector insertion direction side out of the outer circumferential surface of each packing body 5A. The first seal surface 5a makes contact with the casing 10. Each of the second seal surfaces 5b has an end of the connector insertion direction that makes contact with the casing 10, and a part thereof is buried in the connector housing 3. In addition, each of the second seal surfaces 5b makes contact with each of a plurality of shield shells 4 that encapsulate each electric wire 2 accommodated in each tubular portion 3A.

In the packing 5 having the aforementioned configuration, it is possible to integrate a plurality of packings provided in each of the shield shells as many as the number of poles of terminals of the shield connector 1. Therefore, a plurality of connector through-holes provided in the casing 10 can be integrated into a single hole. As a result, it is possible to integrate the waterproof slots of the casing 10 into a single hole. Accordingly, it is possible to simplify fabrication of the waterproof slots for the casing 10 and reduce the fabrication cost. In addition, since the waterproof slots of the casing 10 can be integrated into a single hole, it is possible to suppress a sealing property of the packing 5 from being degraded by a manufacturing variation in the waterproof slots or the tubular portions 3A that may be generated due to a pair of waterproof slots.

In the packing 5 described above, the connecting portion 5B has at least an opening 5e formed in the connector insertion direction and a cavity 5d where a part of the connector housing 3 is inserted from the opening 5e in the insertion state of the connector housing 3. In this manner, since the connecting portion 5B is provided with the cavity 5d, it is possible to maintain the thickness substantially evenly in the circumferential direction from the inner circumferential surface 5c of the packing body 5A to the outer circumferential surface. As the connector housing 3 having elasticity different from that of the packing 5 is partially inserted into the cavity 5d, it is possible to suppress elastic deformation of the outer circumferential surface of each packing body 5A and thus prevent degradation of the sealing property of the packing 5.

The shield connector 1 described above has two or more electric wires 2 each of which is connected to the terminal 6, a connector housing 3 that accommodates the electric wires 2 in at least one or more tubular portions 3A respectively mating with the electric wires 2 to hold each electric wire 2, a plurality of shield shells 4 having an end of the connector insertion direction making contact with the conductive casing 10 and a portion buried in the connector housing 3 to encapsulate each electric wire 2, and an elastic packing 5. The packing 5 is partially interposed between the connector housing 3 and the casing 10 while the connector housing 3 is inserted into the connector through-hole 10b formed in the casing 10. In addition, the packing 5 has a plurality of tubular packing bodies 5A that respectively mates with the tubular portions 3A and have inner circumferential surfaces 5c making contact with the tubular portions 3A, and the connecting portion 5B that connects the neighboring packing bodies 5A. The first seal surface 5a connected to the outer circumferential surface of the connecting portion 5B is provided in the connector insertion direction side out of the outer circumferential surface of each packing body 5A. The second seal surface 5b extending along the circumferential direction is provided in the connector removal direction side opposite to the connector insertion direction out of the outer circumferential surface of each packing body 5A. The first seal surface 5a makes contact with the casing 10. Each of the second seal surfaces 5b makes contact with the shield shell 4.

In the shield connector 1 having the aforementioned configuration, it is possible to integrate a plurality of packings provided for each shield shell depending on the number of poles of terminals of the shield connector 1 and thus integrate a plurality of connector through-holes formed in the casing 10 into a single hole. As a result, it is possible to integrate the waterproof slots of the casing 10 into a single hole. Therefore, it is possible to simplify fabrication of the waterproof slots for the casing 10 and reduce the fabrication cost. In addition, since the waterproof slots of the casing 10 can be integrated into a single hole, it is possible to prevent degradation of the sealing property of the packing 5 generated by a manufacturing variation in the waterproof slots or the tubular portions 3A that may be caused when two waterproof slots are formed.

### Modification

Note that, in the aforementioned description, a part of the connector housing 3, that is, the protrusion 3a is inserted into the cavity 5d. However, the present invention is not limited thereto. Instead, the cavity 5d may be blocked by an insertion member other than the packing 5. If an insertion member formed of a material different from that of the packing 5 is inserted into the cavity 5d in this manner, it is possible to suppress elastic deformation of the outer circumferential surface of each packing body 5A and thus prevent degradation of the sealing property of the packing 5. This insertion member is preferably formed of at least a material having elasticity different from that of the packing 5. In addition, although the cavity 5d is a through-hole penetrating in the connector insertion/removal direction as illustrated in FIG. 4, the cavity 5d may not be a through-hole.

The packing according to the embodiment has a plurality of tubular packing bodies having the inner circumferential surfaces making contact with the tubular portions, and a connecting portion that connects the neighboring packing bodies. Each packing body has a first seal surface connected to an outer circumferential surface of the connecting portion and provided in a connector insertion direction side out of the outer circumferential surface, and a second seal surface formed to extend in a circumferential direction and provided in a connector removal direction side. The first seal surface makes contact with the casing. Each of the second seal surfaces makes contact with each of a plurality of shield shells. As a result, it is possible to integrate a plurality of packings provided for each shield shell depending on the number of poles of terminals of the shield connector and thus integrate a plurality of connector through-holes formed in the casing into a single hole. Consequently, it is possible to simplify fabrication of the waterproof slots for the casing just by forming a single connector through-hole as the waterproof slots in the casing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A packing having elasticity and partially interposed between a connector housing and a conductive casing while the connector housing has an insertion state into a connector through-hole formed in the casing, the packing comprising:
a plurality of tubular packing bodies that respectively mates with a plurality of tubular portions respectively accommodating one or more electric wires connected to terminals in the connector housing, and have inner circumferential surfaces making contact with the tubular portions; and
a connecting portion that connects the neighboring packing bodies, wherein
a first seal surface connected to an outer circumferential surface of the connecting portion is provided in a connector insertion direction side out of an outer circumferential surface of each of the packing bodies,
a second seal surface extending in a circumferential direction is formed in a connector removal direction side opposite to the connector insertion direction out of the outer circumferential surface of each of the packing bodies,
the first seal surface makes contact with the casing,
the second seal surface has an end of the connector insertion direction making contact with the casing and a portion buried in the connector housing, and
the second seal surface makes contact with each of a plurality of shield shells that encapsulate each electric wire accommodated in each of the tubular portions.

2. The packing according to claim 1, wherein
the connecting portion has a cavity, and
the cavity is blocked by an insertion member other than the packing.

3. The packing according to claim 1, wherein
the connecting portion has at least an opening formed in the connector removal direction, and
a cavity is provided to have a portion inserted into the connector housing from the opening in the insertion state.

4. A shield connector comprising:
two or more electric wires each of which is connected to a terminal;
a connector housing provided with at least one or more tubular portions respectively mating with the electric wires to accommodate and hold each of the electric wires; and
a plurality of shield shells each of which has an end of a connector insertion direction making contact with a conductive casing and a portion buried in the connector housing, each of the shield shells encapsulating each of the electric wires; and
an elastic packing, wherein
the packing is partially interposed between the connector housing and the casing while the connector housing has an insertion state into a connector through-hole formed in the casing,
the packing has a plurality of tubular packing bodies that respectively mates with the plurality of tubular portions and have inner circumferential surfaces making contact with the tubular portions, and a connecting portion that connects the neighboring packing bodies,
a first seal surface connected to an outer circumferential surface of the connecting portion is provided in a connector insertion direction side out of an outer circumferential surface of each of the packing bodies,
a second seal surface extending in a circumferential direction is formed in a connector removal direction side opposite to the connector insertion direction out of the outer circumferential surface of each of the packing bodies,
the first seal surface makes contact with the casing, and
each of the second seal surfaces makes contact with each of the shield shell.
